(19) United States
(12) Patent Application Publication
(10) Pub. No.: US 2024/0284478 A1
(43) Pub. Date: Aug. 22, 2024

(54) POWER INFORMATION FOR UPLINK CONFIGURATIONS

(71) Applicant: Samsung Electronics Co., Ltd., Suwon-si (KR)

(72) Inventors: Carmela Cozzo, San Diego, CA (US); Aristides Papasakellariou, Houston, TX (US)

(21) Appl. No.: 18/434,578

(22) Filed: Feb. 6, 2024

Related U.S. Application Data
(60) Provisional application No. 63/446,300, filed on Feb. 16, 2023.
(60) Provisional application No. 63/456,708, filed on Apr. 3, 2023.
(60) Provisional application No. 63/521,587, filed on Jun. 16, 2023.
(60) Provisional application No. 63/536,296, filed on Sep. 1, 2023.
(60) Provisional application No. 63/546,457, filed on Oct. 30, 2023.

(51) Int. Cl. H04W 72/232; H04W 52/36; H04W 72/1268; H04W 80/02

(52) U.S. Cl. CPC H04W 72/232; H04W 52/365; H04W 52/367; H04W 72/1268; H04W 80/02

(57) ABSTRACT

Methods and apparatuses for power information for uplink configurations. A method includes receiving information indicating that a first downlink control information (DCI) format scheduling transmission of a physical uplink shared channel (PUSCH) includes a transform precoding indication (TPI) field and a channel providing a DCI format scheduling transmission of a first PUSCH. The method further includes determining whether the DCI format is the first or a second DCI format and a power headroom report (PHR). When the second DCI format, the PHR includes a single PHR associated with a transform precoding used for the transmission of the first PUSCH. When the first DCI format, the PHR includes first and second PHRs associated with first and second transform precodings, respectively, for the transmission of the first PUSCH. The method further includes transmitting the first PUSCH with the PHR using either the first or second transform precoding.

### CROSS-REFERENCE TO RELATED APPLICATION AND CLAIM OF PRIORITY

This application claims priority under 35 U.S.C. § 119(e) to U.S. Provisional Patent Application No. 63/446,300 filed on Feb. 16, 2023, to U.S. Provisional Patent Application No. 63/456,708 filed on Apr. 3, 2023, to U.S. Provisional Patent Application No. 63/521,587 filed on Jun. 16, 2023, to U.S. Provisional Patent Application No. 63/536,296 filed on Sep. 1, 2023, and to U.S. Provisional Patent Application No. 63/546,457 filed on Oct. 30, 2023. The above-identified provisional patent applications is hereby incorporated by reference in its entirety.

### TECHNICAL FIELD

The present disclosure relates generally to wireless communication systems and, more specifically, relates to power information for uplink configurations.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

This disclosure relates to power information for uplink configurations.

In an embodiment, a user equipment (UE) is provided. The UE includes a transceiver configured to receive information indicating that a first downlink control information (DCI) format scheduling a transmission of a physical uplink shared channel (PUSCH) includes a transform precoding indication (TPI) field and a physical downlink control channel (PDCCH) providing a DCI format scheduling a transmission of a first PUSCH. The TPI field indicates a first transform precoding or a second transform precoding for the transmission of the PUSCH. The UE further includes a processor operably coupled to the transceiver. The processor is configured to determine whether the DCI format is the first DCI format or a second DCI format and a power headroom report (PHR). The second DCI format does not include the TPI field. When the DCI format is the second DCI format, the PHR includes a single PHR associated with a transform precoding used for the transmission of the first PUSCH. When the DCI format is the first DCI format, the PHR includes a first PHR associated with the first transform precoding for the transmission of the first PUSCH and a second PHR associated with the second transform precoding for the transmission of the first PUSCH. The transmission of the first PUSCH uses either the first transform precoding or the second transform precoding. The transceiver is further configured to transmit the first PUSCH with the PHR.

In another embodiment, a base station (BS) is provided. The BS includes a transceiver configured to transmit information indicating that a first DCI format scheduling a reception of a PUSCH includes a TPI field and a PDCCH providing a DCI format scheduling a reception of a first PUSCH. The TPI field indicates a first transform precoding or a second transform precoding for the reception of the PUSCH. The BS further includes a processor operably coupled to the transceiver. The processor is configured to determine whether the DCI format is the first DCI format or a second DCI format and a PHR. The second DCI format does not include the TPI field. When the DCI format is the second DCI format, the PHR includes a single PHR associated with a transform precoding used for the reception of the first PUSCH. When the DCI format is the first DCI format, the PHR includes a first PHR associated with the first transform precoding for the reception of the first PUSCH and a second PHR associated with the second transform precoding for the reception of the first PUSCH. The reception of the first PUSCH is associated with either the first transform precoding or the second transform precoding. The transceiver is further configured to receive the first PUSCH with the PHR.

In yet another embodiment, a method is provided. The method includes receiving information indicating that a first DCI format scheduling a transmission of a PUSCH includes a TPI field and a PDCCH providing a DCI format scheduling a transmission of a first PUSCH. The TPI field indicates a first transform precoding or a second transform precoding for the transmission of the PUSCH. The method further includes determining whether the DCI format is the first DCI format or a second DCI format and a PHR. The second DCI format does not include the TPI field. When the DCI format is the second DCI format, the PHR includes a single PHR associated with a transform precoding used for the transmission of the first PUSCH. When the DCI format is the first DCI format, the PHR includes a first PHR associated with the first transform precoding for the transmission of the first PUSCH and a second PHR associated with the second transform precoding for the transmission of the first PUSCH. The method further includes transmitting the first PUSCH with the PHR. The transmission of the first PUSCH uses either the first transform precoding or the second transform precoding.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example BS according to embodiments of the present disclosure;

FIG. 3 illustrates an example UE according to embodiments of the present disclosure;

FIG. 4 illustrates a flowchart of a method for a UE to provide a power headroom report and an additional value according to embodiments of this disclosure;

FIGS. 5A-B illustrate example diagrams of single entry power headroom report (PHR) medium access control-control element (MAC CE) according to embodiments of this disclosure;

FIGS. 5C-D illustrate example diagrams of multiple entry PHR MAC CE according to embodiments of this disclosure;

FIG. 6 illustrates a flowchart of a method for a UE to provide a second PHR associated with an assumed waveform depending on the indication in a DCI format according to embodiments of this disclosure;

FIG. 7 illustrates a flowchart of a method for a UE to provide a second PHR associated with an assumed waveform when the assumed waveform is not dynamically indicated according to embodiments of this disclosure;

FIG. 8 illustrates a flowchart of a method for a UE to provide a first PHR and a second PHR for respective first and second transmission settings according to embodiments of this disclosure;

FIG. 9 illustrates a flowchart of a method for PHR reporting based on an indication in a DCI format, after a waveform switching indication, according to embodiments of this disclosure;

FIG. 10 illustrates a flowchart of a method for PHR reporting corresponding to a waveform indicated in a DCI format when a UE receives a dynamic waveform switching indication according to embodiments of this disclosure; and

FIG. 11 illustrates a flowchart of a method for PHR reporting subject to a configuration that enables PHR reporting according to embodiments of this disclosure.

### DETAILED DESCRIPTION

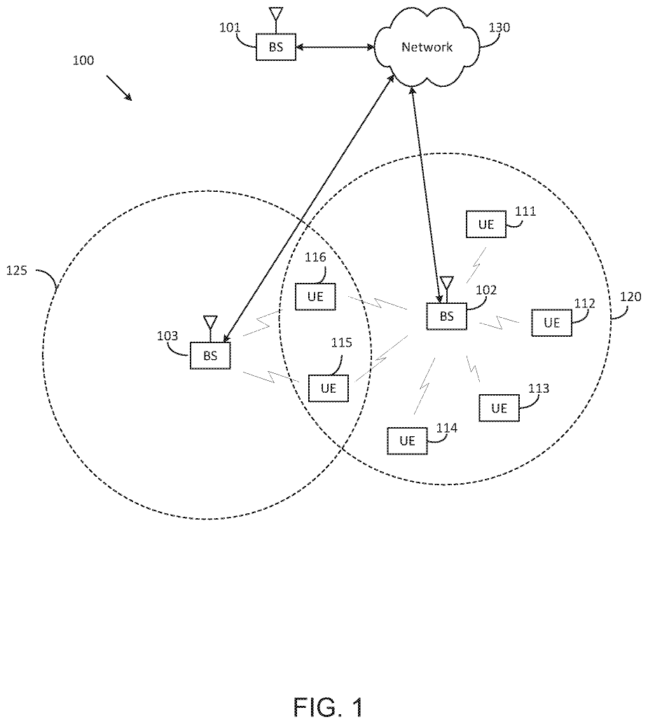

FIGS. 1 through 11, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably-arranged system or device.

The following documents and standards descriptions are hereby incorporated by reference into the present disclosure as if fully set forth herein: 3GPP TS 38.211 v17.4.0, “NR; Physical channels and modulation” (REF1); 3GPP TS 38.212 v17.4.0, “NR; Multiplexing and Channel coding” (REF2); 3GPP TS 38.213 v17.4.0, “NR; Physical Layer Procedures for Control” (REF3); 3GPP TS 38.214 v17.4.0, “NR; Physical Layer Procedures for Data” (REF4); 3GPP TS 38.215 v17.4.0, “NR; Physical Layer Measurements” (REF5); 3GPP TS 38.321 v17.3.0, “NR; Medium Access Control (MAC) protocol specification” (REF6); 3GPP TS 38.331 v17.2.0, “NR; Radio Resource Control (RRC) Protocol Specification” (REF7); and 3GPP TS 38.300 v17.3.0, “NR; NR and NG-RAN Overall Description; Stage 2” (REF8).

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network. The wireless network 100 may be configured to support power information for uplink configurations as discussed in detail below.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof to use power information for uplink configurations. In certain embodiments, one or more of the BSs 101-103 include circuitry, programing, or a combination thereof to enable or support power information for uplink configurations.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

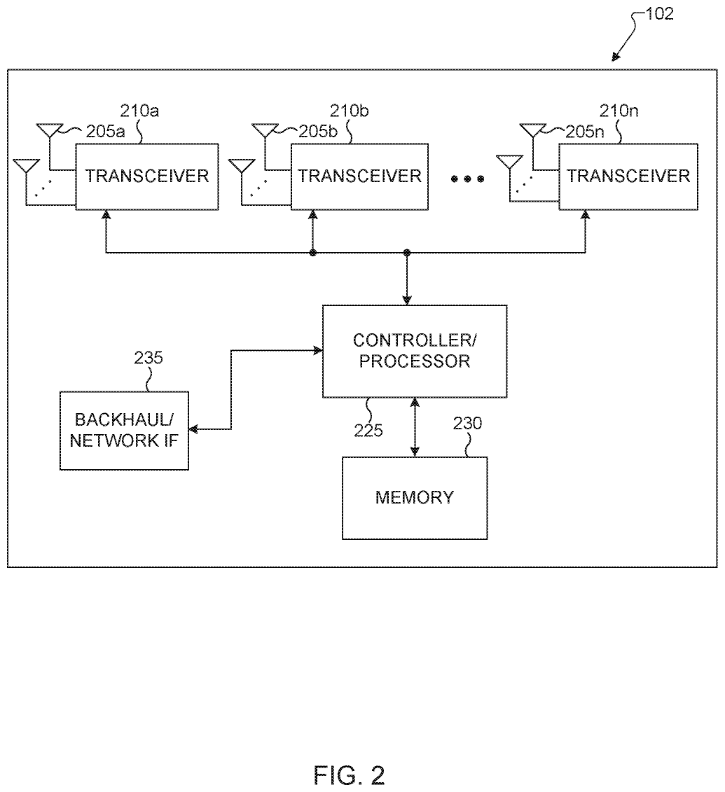

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235. In embodiments of this disclosure, the controller/processor 225 may be configured to execute instructions on memory 230 to facilitate power information for uplink configurations according to at least one of the methods detailed below and in accordance with various embodiments of this disclosure.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as processes to support radio link monitoring in FD systems as discussed in greater detail below. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

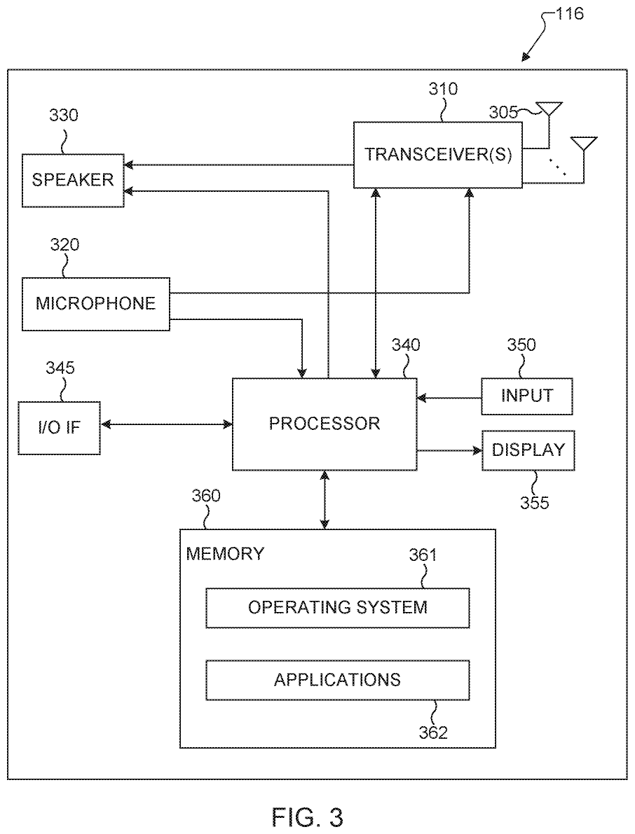

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362. In embodiments of this disclosure, the processor 340 may be configured to execute instructions on memory 360 to use power information for uplink configurations according to at least one of the methods detailed below and in accordance with various embodiments of this disclosure.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, as discussed in greater detail below, the processor 340 may execute processes to identify and use power information for uplink configurations. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

In Rel-17 specifications, the transmission scheme is configured by the network and a reconfiguration is needed to change between CP-OFDM and DFT-S-OFDM. RRC adds some latency which can be beneficial to avoid, especially when switching over to DFT-S-OFDM for cell-edge UEs. Support of DCI-based switching between DFT-S-OFDM and CP-OFDM for UL transmissions will be specified in Rel-18 (Coverage WI).

Additionally, in Rel-17 specifications, the UE determines the power headroom report (PHR) for an activated serving cell based on a reference physical uplink shared channel (PUSCH) transmission that uses the configured waveform. As this disclosure recognizes, for a PHR to be more useful to a gNB that can dynamically indicate the waveform for a scheduled PUSCH transmission, the PHR should be calculated based on the indicated waveform not (or not only) based on the configured waveform.

The present disclosure provides systems and methods for determining power information to assist the gNB to schedule the UE with an optimized transmission scheme.

The disclosure provides systems and methods for determining of power information associated with both the configured waveform and the (new) indicated waveform, MAC CE design for power headroom reports with Cyclic Prefix-Orthogonal Frequency Division Multiplexing (CP-OFDM) and Discrete Fourier Transform-Spread-Orthogonal Frequency Division Multiplexing (DFT-S-OFDM) and for differential reporting. The disclosure further provides systems and methods for PHR reporting triggered by dynamic waveform switching indication in the DCI format (or triggered by a change in number of layers or spatial settings). Additionally, this disclosure provides systems and methods for PHR reporting triggered by 1-bit in DCI format (whether or not to transmit the PHR).

The embodiments of this disclosure apply to any deployments, verticals, or scenarios including physical random access channel (PRACH) transmissions in frequency range 1 (FR1) or frequency range 2 (FR2) or frequency range 3 (FR3), for enhanced mobile broadband (eMBB), ultra reliable low latency communications (URLLC), industrial internet of things (IIoT), extended reality (XR), Massive Machine-Type Communications (mMTC) and IoT including LTE NarrowBand IoT (NB-IoT) or new radio (NR) IoT or Ambient IoT (A-IoT), with sidelink/V2X communications, with multi-TRP/beam/panel, in unlicensed/shared spectrum (NR-U), for non-terrestrial networks (NTN), for aerial systems such as unmanned aerial vehicles (UAVs) such as drones, for private or non-public networks (NPN), for operation with reduced capability (RedCap) UEs, and so on.

Throughout this disclosure, descriptions for operation with carrier aggregation (CA) in the uplink also apply when the UE is configured with two or more UL carriers, and one or more UL carriers are normal carriers and one or more are supplementary uplink (SUL) carriers.

A PHR provides support to a gNB for power control of uplink transmissions. There are three types of PHRs: a first one for PUSCH transmission, a second one for PUSCH and PUCCH transmission in an LTE Cell Group in EN-DC (in TS 37.340), and a third one for sounding reference signal (SRS) transmission on SCells configured with SRS only. Specifically: Type 1 power headroom is the difference between the nominal UE maximum transmit power and the estimated power for uplink shared channel (UL-SCH)/PUSCH transmission per activated Serving Cell; Type 2 power headroom is the difference between the nominal UE maximum transmit power and the estimated power for UL-SCH/PUSCH and PUCCH transmission on Special Cell (SpCell) of the other MAC entity (i.e. Evolved Universal Terrestrial Radio Access (E-UTRA) MAC entity in Evolved Non-standalone Dual Connectivity (EN-DC), NE-DC, and NGEN-DC cases); and Type 3 power headroom is the difference between the nominal UE maximum transmit power and the estimated power for SRS transmission per activated Serving Cell. Throughout this disclosure, terms as PHR, PHR value, PHR information or information associated with a PHR are used interchangeably to refer to any of the PHR types or to power quantities used for the calculation of the PHR described in this disclosure.

In case of CA, when there is no transmission on an activated secondary cell (SCell), a reference power is used to provide a virtual PHR. To allow a network to detect a reduction in transmission power by a UE, PHR reports may also contain Power Management Maximum Power Reduction (P-MPR, in TS 38.101-2) information that the UE uses to ensure compliance with the Maximum Permissible Exposure (MPE) exposure regulation for FR2 for limiting RF exposure on human body. MPE P-MPR is defined as the power back-off to meet the MPE FR2 requirements for a Serving Cell operating on FR2.

A UE provides PHR using a MAC control element (CE). A PHR can be triggered by any of the following events. A timer expires. A timer expires or has expired, and a path loss/RSRP has changed more than a configured value for at least one RS used as path loss/RSRP reference for one activated Serving Cell of any MAC entity of which the active DL BWP is not dormant BWP since the last transmission of a PHR in this MAC entity when the MAC entity has UL resources for new transmission. The path loss variation for one cell assessed above is between the path loss measured at present time on the current path loss reference and the path loss measured at the transmission time of the last transmission of PHR on the path loss reference in use at that time, irrespective of whether the path loss reference has changed in between. A UE can determine a path-loss from an RSRP measurement.

A PHR can further be triggered by: a configuration or reconfiguration of the power headroom reporting functionality by upper layers, when the PHR function is enabled, activation of an SCell of any MAC entity with configured uplink corresponding to a DL BWP that is not set to dormant BWP, activation of an SCG, addition of the PSCell except if the SCG is deactivated (i.e. PSCell is newly added or changed).

A PHR can further be triggered when a timer expires or has expired, when the MAC entity has UL resources for new transmission, and for any of the activated Serving Cells of any MAC entity with configured uplink, there are UL resources allocated for transmission or there is a PUCCH transmission on that cell, and the required power backoff due to power management (as allowed by P-MPRc as specified in TS 38.101-1, TS 38.101-2, and TS 38.101-3) for that cell has changed more than a configured value since the last transmission of a PHR when the MAC entity had UL resources allocated for transmission or PUCCH transmission on that cell.

A PHR can also be triggered by switching of activated BWP from dormant BWP to non-dormant DL BWP of an SCell of any MAC entity with configured uplink.

A PHR can be triggered when MPE reporting is configured and a corresponding MPE timer is not running: the measured P-MPR applied to meet FR2 MPE requirements as specified in TS 38.101-2 is equal to or larger than a threshold for at least one activated FR2 Serving Cell since the last transmission of a PHR in this MAC entity; or the measured P-MPR applied to meet FR2 MPE requirements as specified in TS 38.101-2 has changed more than a configured value for at least one activated FR2 Serving Cell since the last transmission of a PHR due to the measured P-MPR applied to meet MPE requirements being equal to or larger than a threshold in this MAC entity. In this case the PHR is referred to as ′MPE P-MPR report′. Triggering a PHR when the required power backoff due to power management decreases only temporarily (e.g., for up to a few tens of milliseconds) should be avoided so that such temporary decrease is not reflected in the values of PCMAX,f,c or PHR when a PHR is triggered by other triggering conditions.

A UE sets its configured maximum output power P_{CMAX,f,c} for carrier f of serving cell c in each slot between an upper limit and a lower limit as follows:

P_{CMAX_L,f,c}≤P_{CMAX,f,c}≤P_{CMAX_H,f,c} with P_{CMAX_L,f,c}=MIN {P_{EMAX,c}−ΔT_{C,c}, (P_{PowerClass}−ΔP_{Powerclass})−MAX(MAX(MPR_{c}+A-MPR_{c}, Δ-MPR_{c})+ΔT_{IB,c}+ΔT_{C,c}+ΔT_{RxSRS}, P-MPR_{c})}, and P_{CMAX_H,f,c}=MIN {P_{EMAX,c}, P_{PowerClass}−ΔP_{PowerClass}}, where P_{EMAX,c} is provided by higher layer parameters and depends on UE capability of using power boosting with a modulation, for example Pi/2 BPSK modulation, in certain bands for a number of slots of a radio frame, P_{PowerClass} is the maximum UE power specified per power class without taking into account tolerances defined per band or band combinations, and ΔP_{PowerClass} indicates a value (3 dB or 0 dB) depending on a UE capability of supporting a maximum duty cycle defined for the UE larger power class, if present, and on a percentage of uplink symbols transmitted in a certain evaluation period being larger than 25% or 50%. The maximum duty cycle is indicated for a UE power class and indicates the maximum percentage of uplink symbols that can be transmitted in a certain evaluation period using the indicated power class in order to meet SAR requirements. The maximum duty cycle can be indicated for PC2 [maxUplinkDutyCycle-PC2-FR1] or for PC1.5 [maxUplinkDutyCycle-PC1dot5-MPE-FR1]. Additional power tolerances provided by ΔT_{IB,c}+ΔT_{C,c}+ΔT_{RxSRS} which are related to operation with CA, SUL or DC, in certain band or band combination, or to SRS transmission. For the UE capability of supporting a maximum duty cycle, the UE indicates a maximum percentage of uplink symbols transmitted in a certain evaluation period using the transmit power of the UE power class to meet specific absorption requirements (SAR) requirements.

MPR_{c} and A-MPR_{c} for serving cell c, are related to a UE reducing a maximum output power due to higher order modulation and transmit bandwidth configurations, or due to additional emission requirements signaled by the network, respectively. An additional emission requirement is associated with a unique network signalling (NS) value indicated in RRC signalling by an NR frequency band number of the applicable operating band and by an associated value, in corresponding RRC information elements. To meet the additional requirements, additional maximum power reduction (A-MPR) is allowed for the maximum output power and, unless specified otherwise, the total reduction to UE maximum output power is the maximum of MPR and A-MPR, i.e., max(MPR, A-MPR).

MPR values are specified based on the RB allocation. For example, there is a set of MPR values for SRS, PUCCH formats 0, 1, 3 and 4, and PRACH are specified for QPSK modulated DFT-s-OFDM of equivalent RB allocation, and another set of MPR values for PUCCH format 2 are specified for QPSK modulated CP-OFDM of equivalent RB allocation. For RB allocations, N_{RB} is the maximum number of RBs for a given channel bandwidth and sub-carrier spacing, where max( ) indicates the largest value of all arguments and floor(x) is the greatest integer that is smaller than or equal to x, RB_{Start,Low}=max(1, floor(L_{CRB}/2)), and RB_{start,High}=N_{RB}−RB_{Start,Low}−L_{CRB}. The RB allocation is an Inner RB allocation if the following conditions are met: RB_{start,Low}≤RBₛₜₐᵣₜ≤RB_{start,High}, and L_{CRB}≤ceil(N_{RB}/2) where ceil(x) is the smallest integer that is larger than or equal to x. For pi/2 BPSK modulation, an RB allocation is an Edge RB allocation if RB(s) is (are) allocated at the lowermost or uppermost edge of the channel and L_{CRB}≤2 RBs. The RB allocation is an Outer RB allocation for all other allocations that are not an Inner RB allocation or, when applicable, Edge RB allocation. An RB allocation is considered as almost contiguous allocation if CP-OFDM allocation satisfies the following conditions: N_{RB_gap}/(N_{RB_alloc}+N_{RB_gap})≤0.25 and N_{RB_alloc}+N_{RB_gap} is larger than 106, 51 or 24 RBs for 15 kHz, 30 kHz or 60 kHz SCS respectively where N_{RB_gap} is the total number of unallocated RBs between allocated RBs and N_{RB_alloc} is the total number of allocated RBs. The size and location of allocated and unallocated RBs are restricted by RBG parameters specified in clause 6.1.2.2 of REF4. For these almost contiguous signals in power class 2 and 3, the specified MPR values are increased by CEIL{10 log₁₀(1+N_{RB_gap}/N_{RB_alloc}), 0.5} dB, where CEIL{x,0.5} means x rounding upwards to closest 0.5 dB. The parameters of RB_{Start,Low} and RB_{start,High} to specify valid RB allocation ranges for Outer and Inner RB allocations are defined as RB_{Start,Low}=max(1, floor((N_{RB_alloc}+N_{RB_gap})/2)) and RB_{Start,High}=N_{RB}−RB_{Start,Low}−N_{RB_alloc}−N_{RB_gap}.

P-MPR_{c} is the power management maximum power reduction used for a UE to fulfill the SAR requirements, for example for ensuring compliance with applicable electromagnetic energy absorption requirements and addressing unwanted emissions/self desense requirements in case of simultaneous transmissions on multiple RATs, or ensuring compliance with applicable electromagnetic energy absorption requirements in case of proximity detection is used to address such requirements that require a lower maximum output power, and it is applied for serving cell c for the above cases. For UE conducted conformance testing P-MPR_{c} is set to 0 dB. The scope of introducing P-MPRc in the P_{CMAX,f,c} equation is for the UE to report to the gNB information for an available maximum output transmit power. That information can be used by the gNB for scheduling decisions. Thus, P-MPRc may impact the uplink performance/throughput for a UE.

A UE can indicate a capability to transmit at a maximum output power that is larger than what the power class for an UL CA/DC configuration allows for single carrier operation. For example, for the UE supporting PC3 (23 dBm) in one band (TDD or FDD) and PC2 (26 dBm) in another band (TDD), the carrier aggregation (CA) configuration can set the maximum transmit power limit according to PC2 (26 dBm) and the maximum composite power from both transmitters would be limited to 26 dBm. With the increased maximum output power capability, the UE is allowed to transmit with the power combined over the two carriers when simultaneously transmitting at maximum power on each carrier. In this example, the maximum allowed power would be the aggregated value of 27.8 dBm. The UE capability is referred to as HigherPowerLimitCADC capability.

For uplink intra-band CA, the UE sets its configured maximum output power P_{cMAx,c} for serving cell c and its total configured maximum output power P_{CMAX}. The configured maximum output power P_{CMAX,c} on serving cell c is defined as above by setting MPR_{c}=MPR and A-MPR_{c}=A-MPR with MPR and A-MPR determined for uplink CA operation. Regarding PHR, the following exception applies: if the UE is configured with multiple uplink serving cells, the power P_{CMAX,c} used for the purpose of PHR reporting on first serving cell c=c₁ does not consider for computation of the PHR transmissions on a second serving cell c₂ as exempted in subclause 7.7.1 in REF3. There is one power management term for the UE, denoted P-MPR, and P-MPR_{c}=P-MPR. A UE sets its total configured maximum output power P_{CMAX} within upper and lower bounds as P_{CMAX_L}≤P_{CMAX}≤P_{CMAX_H}. For uplink intra-band contiguous CA when same slot pattern is used in all aggregated serving cells, P_{CMAX_L}=MIN{10 log₁₀ Σp_{EMAX,c}−ΔT_{C}, P_{EMAX,CA}, (P_{PowerClass,CA}−ΔP_{PowerClass,CA})−MAX(MAX(MPR, A-MPR)+ΔT_{IB,c}+ΔT_{C}+ΔT_{RxSRS}, P-MPR_{c})}, and P_{CMAX_H}=MIN{10 log₁₀ Σp_{EMAX,c}, P_{EMAX,CA}, P_{PowerClass,CA}−ΔP_{PowerClass,CA}}.

For uplink inter-band CA, the UE sets its configured maximum output power P_{CMAx,c} for serving cell c and its total configured maximum output power P_{CMAX}. The configured maximum output power P_{CMAX,c} on serving cell c is defined as above, except that the UE power class for serving cell c on the specific operating band is determined by the RRC powerClassPerBand as indicated for the band combination, if signalled. For uplink inter-band carrier aggregation, MPR_{c} and A-MPR_{c} apply per serving cell c. P-MPR_{c} accounts for power management for serving cell c. The UE calculates P_{CMAX},c under the assumption that the transmit power is increased independently on all component carriers. The UE sets its total configured maximum output power P_{CMAX} within upper and lower bounds as P_{CMAx_L}≤P_{CMAX}≤P_{CMAX_H}. For uplink inter-band CA with one serving cell c per operating band and when a same slot symbol pattern is used in all aggregated serving cells, P_{CMAX_L}=MIN {10 log₁₀ ΣMIN [p_{EMAX,c}/(Δt_{C,c}), p_{PowerClass.c}/(MAX(mpr_{c}·Δmpr_{c}, a-mpr_{c})·Δt_{C,c}·Δt_{IB,c}·Δt_{RxSRS,c}), p_{PowerClass,c}/pmpr_{c}], P_{EMAX,CA}, P_{PowerClass,CA}-ΔP_{PowerClass, CA}}, and P_{CMAX_H}=MIN{10 log₁₀ Σp_{EMAX,c}, P_{EMAX,CA}, P_{PowerClass,CA}-ΔP_{PowerClass}, CA}.

When a UE indicates a HigherPowerLimitCADC capability for a CA configuration and ΔP_{PowerClass, CA}=0, the maximum UE power as specified for the UE power class P_{PowerClass,CA} for the calculation of both P_{CMAX_L} and P_{CMAX_H} can be replaced by the sum of the UE power on each carrier as 10 log₁₀ Σp_{PowerClass,c}.

The maximum duty cycle is indicated for a UE power class and indicates the maximum percentage of uplink symbols that can be transmitted in a certain evaluation period using the indicated power class in order to meet SAR requirements.

DFT-S-OFDM waveform is beneficial for UL coverage limited scenario because of its lower PAPR compared with CP-OFDM waveform. A DFT-S-OFDM transmission scheme would likely be used with lower MCS values, lower coding rates and lower modulation order, and be used for UEs in coverage limited scenarios operating at low SNR. A CP-OFDM transmission scheme would likely be used with higher MCS values and for UEs not in coverage limited situations operating at higher SNRs. The UE can be configured with different MCS tables for CP-OFDM and for DFT-S-OFDM, and also different tables for 64QAM and 256QAM. As a UE experiences different channel conditions within the cell and its operating SINR changes, it can be beneficial for the gNB to change the transmission scheme of the UE in order to optimize performance and/or to maintain the link. In current specifications, the transmission scheme is configured by the network and a reconfiguration is needed to change between CP-OFDM and DFT-S-OFDM. This is reasonable as a gNB cannot make instantaneous decisions for a UE and a change in waveform/coverage is typically decided based on RSRP reports or long term BLER statistics. Nevertheless, RRC adds some latency which can be beneficial to avoid especially when switching over to DFT-S-OFDM for cell-edge UEs. Thus, support of dynamic switching between DFT-S-OFDM and CP-OFDM for UL transmissions is beneficial. A dynamic indication can be DCI-based or by MAC CE.

When a gNB can dynamically change the waveform of the uplink transmission scheme, for example between DFT-S-OFDM and CP-OFDM, or generally between a first waveform and a second waveform, the gNB needs to acquire knowledge of the changing channel conditions of the UE. A power headroom report (PHR) from the UE can help the gNB to make a more informed decision when to change the waveform. The UE determines the PHR for an activated serving cell based on a reference PUSCH transmission that uses the configured waveform. If the PHR is determined based on the waveform the UE could switch to, the PHR would be more useful for the gNB to decide whether to schedule the UE to transmit with the current waveform or switches to another waveform. If the PHR can provide information associated with both waveforms, the switching of waveform can be further optimized so that the UE can transmit with the waveform that provides better performance. Thus, there is a need to enhance the PHR in order to optimize the UL transmission scheme.

The present disclosure provides systems and methods for determining power headroom reports to assist the gNB to schedule the UE with an optimized transmission scheme, determining power headroom reports associated with different waveforms, and reporting the power headroom based on an event triggered by an indication in a DCI format.

A UE determines a Type 1 UE power headroom report that is valid for PUSCH transmission occasion ⁱ on active UL BWP ^{b} of carrier ^{f} of serving cell ^{c}, based on an actual transmission or a reference transmission or format according to higher layer signalling. If the UE determines that a Type 1 power headroom report for an activated serving cell is based on an actual PUSCH transmission then, for PUSCH transmission occasion i on active UL BWP b of carrier f of serving cell c, the UE computes the Type 1 power headroom report as

$$\\ {PH}_{type 1 , b , f , c ,} ( i , j , {q}_{d} , l ) = {P}_{CMAX , f , c} ( i ) - \{ \begin{matrix}{P}_{{O}_{PUSCH} , b , f , c} ( j ) + 10 {log}_{10} ( {2}^{{}_{} μ} * {M}_{RB , b , f , c}^{{}_{} PUSCH} ( i ) ) + \\ {α}_{b , f , c} ( j ) * {PL}_{b , f , c} ( {q}_{d} ) + {Δ}_{TF , b , f , c} ( i ) + {f}_{b , f , c} ( i , l )\end{matrix} \} [ db ]$$

where P_{CMAX,f,c}(i), P_{O_PUSCH,b,f,c}(j) M_{RB,b,f,c} ^{PUSCH}(i), PL_{b,f,c}(q_{d}), Δ_{TF,b,f,c}(i) and f_{b,f,c}(i,l) are defined in clause 7.1.1 of REF3.

In a first embodiment, a UE can determine a Type 1 UE power headroom report that is valid for PUSCH transmission occasion i on active UL BWP b of carrier f of serving cell c, based on an actual transmission or a reference transmission or format according to higher layer signalling, assuming more than one waveforms. For example, if the UE can transmit with DFT-S-OFDM and CP-OFDM, the UE calculates a first PHR for the actual transmission assuming DFT-S-OFDM and a second PHR for the actual transmission assuming CP-OFDM, wherein DFT-S-OFDM is the currently used waveform as configured by a higher layer parameter and/or indicated by a DCI format that includes a field for dynamic waveform switching, and CP-OFDM is the other waveform that the UE can use; or vice versa the UE calculates a first PHR for the actual transmission assuming CP-OFDM and a second PHR for the actual transmission assuming DFT-S-OFDM, wherein CP-OFDM is the currently used waveform as configured by a higher layer parameter and/or indicated by a DCI format that includes a field for dynamic waveform switching, and DFT-S-OFDM is the other waveform that the UE can use, if configured to calculate the PHR for the actual transmission. If the UE is configured to use the reference format, the UE would calculate a first PHR for the reference transmission assuming DFT-S-OFDM and a second PHR for the reference transmission assuming CP-OFDM. The UE then reports an information to the gNB that is associated with the PHR values calculated for the two waveforms. Whether the UE uses the actual transmission, or the reference format for determining the PHR value or an information associated with the PHR depends on a configuration and/or whether a reference transmission or format is provided or not.

In a first example, the UE reports both first and second PHR values.

In a second example, the UE reports a first PHR value associated with a first waveform, and additionally reports a differential value D that can be obtained as the difference between the first PHR value and a second PHR value associated with a second waveform, or as the difference between the second PHR value and the first PHR value. The first PHR value can be associated with the waveform used in the actual transmission and the second PHR value can be associated with the other waveform that is not used in the actual transmission, or the waveforms used in first and second PHR calculations to determine the first PHR value and the second PHR value are configured and the differential value is calculated as the difference between first and second PHR values. Alternatively, or additionally, the differential value can be obtained as the difference between other respective entries in the calculation of the PHR.

For example, the UE can report a path loss, or a differential value for the path loss obtained as the difference between the path loss values in two different time instances according to a configuration, wherein the differential path loss value is reported in the same MAC CE that includes the PHR value corresponding to the current waveform.

It is possible that along with the PHR report, the UE reports the P_{CMAX,f,c} (i) value used in the calculation of the reported PHR. It is also possible that, when the UE is configured with CA, along with the PHR report, the UE reports P_{CMAX_L} value and/or P_{CMAX_H} value used in the calculation of the reported PHR. It is also possible that, when the UE is configured with CA, along with the PHR report, the UE reports P_{PowerClass,CA}, or ΔP_{PowerClass,CA}, or P_{PowerClass,CA}−ΔP_{PowerClass,CA} that are used in the reported PHR.

For the case that the UE reports a first PHR and an information associated with a second PHR, corresponding to a first waveform and a second waveform, wherein the first waveform is the waveform used in the actual PUSCH transmission and the second waveform is the waveform indicated in a DCI format by the dynamic waveform switching field (also referred as the assumed waveform or assumed PUSCH transmission), wherein the DCI format is a DCI format 0_1, or 0_2, or 0_3, the UE would report a first P_{CMAX,f,c}(i) value used in the calculation of the first PHR and associated with the first waveform and a second P_{CMAX,f,c}(i) value used in the calculation of the second PHR and of the information associated with the second PHR, that are associated with the second waveform.

When the UE is configured with CA, and the indication of dynamic waveform switching is received in each carrier, the UE reports the first PHR associated with the first waveform and the information associated with the second PHR that is associated with the second waveform, and also reports P_{CMAX,f,c}(i) values for the corresponding first PHR and second PHRs for each carrier c.

When the UE is configured with CA on multiple carriers, and the indication of dynamic waveform switching is received in a set of carriers of the multiple carriers, wherein the set of carriers may include one or more carriers of the multiple carriers, the UE reports the first PHR associated with the first waveform and the information associated with the second PHR that is associated with the second waveform, and also reports P_{CMAX,f,c}(i) values for the corresponding first and second PHRs for each carrier c of the set of carriers. It is possible that when the PUSCH transmissions on the multiple carriers are scheduled by corresponding DCI formats, only a set of DCI formats corresponding to a set of carriers includes the indication of waveform switching, and accordingly the UE reports PHR information, and/or P_{CMAX,f,c}(i), associated with the first waveform and the second waveform, only for the set of carriers. It is possible that a UE configured for operation with CA on multiple carriers, does not expect that for a first set of carriers from the multiple carriers corresponding DCI formats scheduling PUSCH transmissions include a field for dynamic waveform switching and a second set of carriers from the multiple carriers corresponding DCI formats scheduling PUSCH transmissions do not include a field for dynamic waveform switching. It is also possible that a UE configured for operation with CA on multiple carriers, does not expect that for a first set of carriers from the multiple carriers corresponding DCI formats scheduling PUSCH transmissions include a field for dynamic waveform switching that indicates a waveform different than the actual waveform and a second set of carriers from the multiple carriers corresponding DCI formats scheduling PUSCH transmissions include a field for dynamic waveform switching that indicates a same waveform different than the actual waveform.

When the UE is configured with CA on multiple carriers, and the indication of dynamic waveform switching is received in a DCI format 0_3 that schedules PUSCH transmissions on the multiple carriers, the UE reports the first PHR associated with the first waveform and the information associated with the second PHR that is associated with the second waveform, and also reports P_{CMAX,f,c}(i) values for the corresponding first and second PHRs for each carrier c of the multiple carriers, wherein the first P_{CMAX,f,c}(i) and the second P_{CMAX,f,c}(i) are associated with the carrier c.

For the case that the UE reports both first and second PHR values associated with respective first and second waveforms, wherein the first waveform is the waveform used in the actual PUSCH transmission and the second waveform is the waveform indicated in a DCI format by the dynamic waveform switching field (also referred as the assumed waveform or assumed PUSCH transmission), wherein the DCI format is a DCI format 0_1, or 0_2, or 0_3, the UE would report a first P_{CMAX,f,c} (i) value used in the calculation of the first PHR and associated with the first waveform and a second P_{CMAX,f,c}(i) value used in the calculation of the second PHR and associated with the second waveform, wherein the first P_{CMAX,f,c}(i) and the second P_{CMAX,f,c}(L) are associated with the carrier c.

When the UE is configured with CA, and the indication of dynamic waveform switching is received in each carrier, the UE reports the first PHR associated with the first waveform and the second PHR associated with the second waveform, and also reports P_{CMAX,f,c}(i) values for the corresponding first and second PHRs for each carrier c.

When the UE is configured with CA on multiple carriers, and the indication of dynamic waveform switching is received in a set of carriers of the multiple carriers, wherein the set of carriers may include one or more carriers of the multiple carriers, the UE reports the first PHR associated with the first waveform and the second PHR associated with the second waveform, and also reports P_{CMAX,f,c}(i) values for the corresponding first and second PHRs for each carrier c of the set of carriers.

When the UE is configured with CA on multiple carriers, and the indication of dynamic waveform switching is received in a DCI format 0_3 that schedules PUSCH transmissions on the multiple carriers, the UE reports the first PHR associated with the first waveform and the second PHR associated with the second waveform, and also reports P_{CMAX,f,c}(i) values for the corresponding first and second PHRs for each carrier c of the multiple carriers.

A UE may report a ΔP_{PowerClass,CA} in a same MAC CE used for reporting the first PHR and the second PHR. Alternatively, the ΔP_{PowerClass,CA} can be reported in a different MAC CE than the one used for reporting the first PHR and the second PHR. It is possible that the ΔP_{PowerClass,CA} is reported in the same MAC CE that includes the first PHR associated with the waveform of the actual PUSCH transmission, independently on whether the second PHR is reported or not. It is also possible that the ΔP_{PowerClass,CA} is reported in the same MAC CE that includes the first PHR associated with the waveform of the actual PUSCH transmission, independently on whether the second PHR is reported or not, or on whether the DCI format(s) scheduling the PUSCH transmission(s) includes a field for dynamic waveform switching or not. It is also possible that the UE reports the ΔP_{Powerclass},associated with the power class of a carrier, and when the UE is configured with CA, the UE may report the ΔP_{Powerclass}, associated with the multiple carriers that are configured for CA operation, or may report the ΔP_{Powerclass}, for each of the carriers, or may only report the ΔP_{Powerclass} for the carrier with the largest power class. This can be subject to a configuration, and to a UE capability.

In a third example, the UE reports the PHR value associated with the first waveform, and additionally reports an information that indicates whether the first PHR value associated with the first waveform is larger or smaller than the second PHR value associated with the second waveform. For example, the UE can report “0” to indicate that the two PHR values are within a given dB range, report “−1” if the second PHR value is larger than the first PHR value of a given dB value, and report “1” if the second PHR value is smaller than the first PHR value of a given dB value. The given dB range and/or the given dB value can be configured by higher layers, wherein the given dB range can be the value set for a first threshold and the given dB value can be the values set for a second threshold. Based on the first threshold the UE informs the gNB that the difference between the first PHR and the second PHR is above or below the first threshold. Based on the second threshold the UE informs the gNB whether the first PHR is larger than the second PHR of a value equal to the second threshold. It is possible that the given dB values used to inform the gNB of “−1” or “1” can be different. In one example, a 1-bit field can be used to indicate whether the first PHR is larger or smaller than the second PHR, for example a value of “0” indicates that the first PHR is larger than the second PHR and a value of “1” indicates that the first PHR is smaller than the second PHR, or vice versa, and a value for a single threshold can be configured. The first PHR can be associated with the actual waveform and the second PHR can be associated with the other waveform. In one example, a 2-bit field can be used for the report, with one value indicating a UE request to change waveform and the other three values providing the information described as “0”, “1” or “−1” above, respectively. In one example, a 2-bit field is used for the indication: a value of “00” indicates that the two PHR values are within a given dB range, a value of “01” indicates that the second PHR value is smaller than the first PHR value of a given dB value, a value of “10” indicates that the second PHR value is larger than the first PHR value of a given dB value, and a value of “11” is a reserved field, or indicates that the UE does not require a waveform change, or indicates that the UE is not in a power limited situation.

In a fourth example, the UE reports a differential value D that can be obtained as the difference between a first PHR value associated with a current waveform and a second PHR value associated with another waveform, wherein the PHR values are obtained considering a reference transmission or format or the current scheduled transmission according to a higher layer configuration. The differential value D can be reported at a different time of the PHR reporting with a same or different periodicity of the PHR reporting according to a higher layer configuration, wherein the PHR reporting refers to the PHR corresponding to the transmission with the actual waveform, and the differential value D refers to the difference of PHR values corresponding to the transmission with the actual waveform and the transmission with another waveform.

In a further example, the differential value D is reported after the waveform changes. For example, the value D can be reported after (at least) a given time interval from the time when the UE receives the waveform indication, or from the time the UE starts transmitting the PUSCH scheduled by the DCI format that includes the waveform indication, or from the time when the UE completes the PUSCH transmission scheduled by the DCI format that includes the waveform indication.

In other examples, the UE reports the differential value D instead of the PHR in the first report after the waveform changes.

In more examples, the UE reports the differential value D and the PHR in a first report after the waveform changes and then reports the PHR in subsequent reports when the UE reports periodically the PHR.

In additional examples, the UE reports the differential value D instead of the PHR, or in addition to the PHR, when the value D report is triggered by MAC CE.

In yet other examples, the UE reports the differential value D every time the PHR is reported.

When the reporting of the differential value D is configured, a timer can be used. The timer can start when the waveform changes, and when the timer expires a differential value D is reported and the timer may be restarted, or the differential value D is reported until the timer expires.

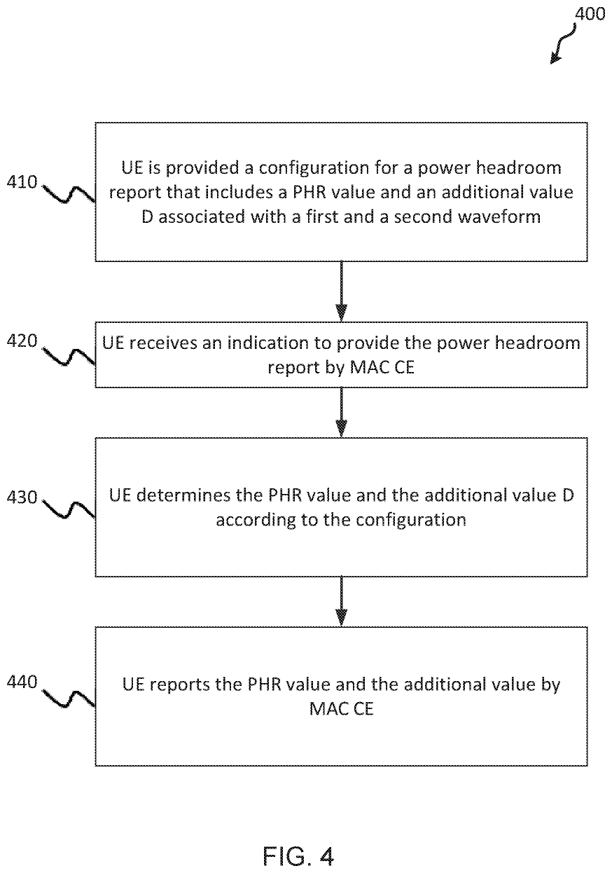

FIG. 4 illustrates a flowchart of a method 400 for a UE to provide a power headroom report and an additional value according to embodiments of the present disclosure. The embodiment of the flowchart of method 400 illustrated in FIG. 4 is for illustration only. FIG. 4 does not limit the scope of this disclosure to any particular implementation. In embodiments of this disclosure, one or more steps of the method 400 may be implemented as instructions, stored on a memory 360, executable by a processor 340 of a UE, e.g., UE 116. In embodiments of this disclosure, a corresponding version of the method 400 may be implemented as instructions, stored on a memory 230, executable by a processor 225 of a gNB, e.g., gNB 102.

At 410, a UE (e.g., UE 116) is provided a configuration for a power headroom report that includes a PHR value, and an additional value D associated with a first and a second waveform. At 420, the UE receives an indication to provide the power headroom report by MAC CE. At 430, the UE determines the PHR values and the additional value D according to the configuration. At 440, the UE reports the PHR value and the additional value D by MAC CE. A similar procedure as the procedure described by steps 410 to 440 for reporting the differential value D in addition to the PHR value applies when the UE reports a second PHR instead of the difference value as described above.

The reporting of the value D may be as follows. The Single Entry PHR MAC CE is identified by a MAC subheader with a corresponding LCID as specified in Table 6.2.1-2 in REF6. It has a fixed size and includes two octets including. R: Reserved bit, set to 0. Power Headroom (PH): this field indicates the power headroom level. The length of the field is 6 bits. P: If mpe-Reporting-FR2 is configured and the Serving Cell operates on FR2, the MAC entity shall set this field to 0 or 1 otherwise: PCMAX,f,c field indicates the PCMAX,f,c used for calculation of the PHR field and, if mpe-Reporting-FR2 is configured, and the Serving Cell operates on FR2, and if the P field is set to 1, MPE field indicates the applied power backoff to meet MPE requirements.

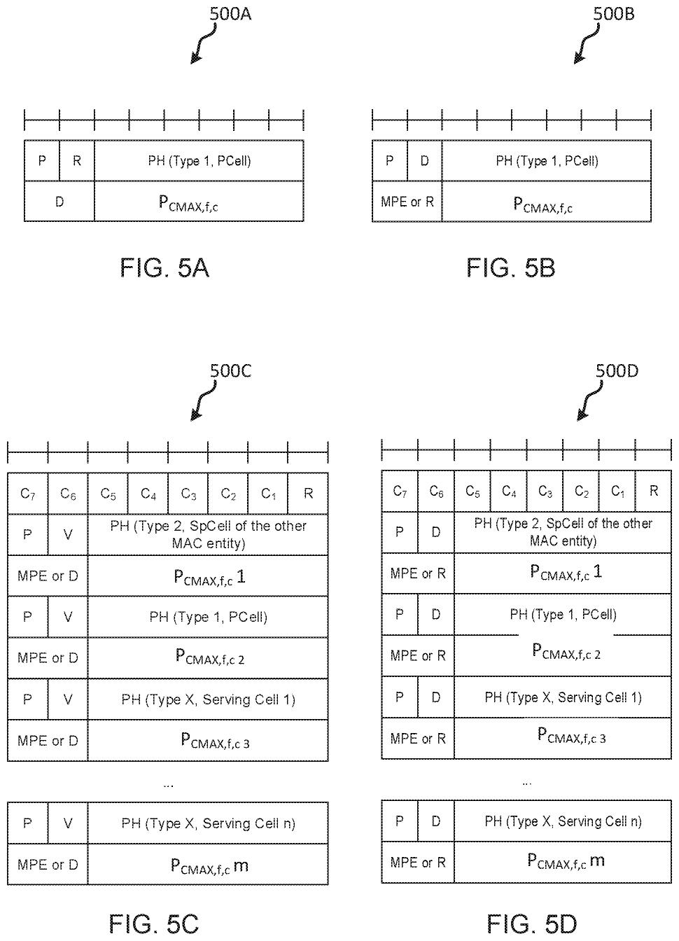

FIGS. 5A-D illustrate diagrams of examples of single entry PHR MAC CE (diagram 500A and diagram 500B) or examples of multiple entry PHR MAC CE (diagram 500C and diagram 500D) according to embodiments of the present disclosure. The embodiment of the diagrams 500A-D illustrated in FIGS. 5A-D are for illustration only. FIGS. 5A-D do not limit the scope of this disclosure to any particular implementation.

In a first example, as show in diagram 500A, when the reporting of the value D is configured, the Single Entry PHR MAC CE can include a field of 2 bits for D.

In a second example, as shown in diagram 500B, when the reporting of the value D is configured, the Single Entry PHR MAC CE can include a field of 1 bit for D.

As illustrated in diagram 500C, it is possible that the value D is included in the Multiple Entry PHR MAC CE. The Multiple Entry PHR MAC CE is identified by a MAC subheader with a corresponding LCID (as specified in Table 6.2.1-2 in REF6). When the reporting of the value D is configured, the Multiple Entry PHR MAC CE can include a field of 2 bits for D as follows for the case of Multiple Entry PHR MAC CE with the highest ServCellIndex of Serving Cell with configured uplink is less than 8 as shown in diagram 500C.

In other embodiments, as shown in diagram 500D, if the V field that indicates if the PHR value is based on a real (or actual) transmission or a reference format is not present, and the this information is fixed when D is reported, or configured by an RRC parameter, the D can be reported in a field of 1 bit as follows for the case of Multiple Entry PHR MAC CE with the highest ServCellIndex of Serving Cell with configured uplink is less than 8.

In more embodiments of this disclosure, a reporting of a PHR corresponding to a waveform and a number of layers is provided.

When a UE (e.g., UE 116) is capable of transmitting with DFT-S-OFDM waveform with multiple layers, the UE can receive a configuration for a reference PUSCH transmission with multi-layer DFT-S-OFDM waveform in an activated serving cell that the UE uses to calculate a corresponding PHR. The UE (e.g., UE 116) can provide the PHR corresponding to the reference PUSCH transmission with multi-layer DFT-S-OFDM waveform by MAC CE, and the report can be triggered by events similar to events that can trigger the PHR for a different reference PUSCH transmission. For example, a timer expiration, or a path loss change, or a configuration or reconfiguration of the power headroom reporting functionality by upper layers, or a cell activation, or a switching of an activated BWP from dormant BWP to non-dormant DL BWP, etc. When the PHR reporting is triggered, the UE reports the PHR based on the PHR configuration. It is possible that the UE is configured with more than one PHR configuration and the UE is not expected to report the PHR corresponding to a first and a second PHR configuration using the same MAC CE. For example, events that can trigger the report a first PHR are independent of events that trigger a second PHR, and the actual reporting happens at independent time instances. Alternatively, or additionally, a same event can trigger first and second PHR reporting, wherein the first and second PHR values can be provided in same or different MAC CE. When provided in a same MAC CE, the second PHR reporting can be reported as an absolute value or a differential value respect to the first PHR report. For example, the first PHR report is provided using 6 bits and the differential value between first and second PHR is provided by a 2-bit field in the same MAC CE. For example, if the UE is configured with DFT-S-OFDM waveform with single layer, the UE can be configured with reporting PHR for DFT-S-OFDM with multiple layers (e.g., 2 layers) waveform and PHR for CP-OFDM waveform, and be configured with corresponding reference PHR configuration to use for the calculation of the PHR values. The UE may report the largest PHR value using a 6-bit field in MAC CE and indicate whether the reported PHR value refers to the first or second waveform using a 1-bit field, wherein the 1-bit field can be provided in the same MAC CE in a reserved field or in the V field, and the P_{CMAX,f,c} provided in the same MAC CE is the one used for the calculation of the reported (in this case the largest between the two values) PHR field. For example, a value of “0” for the 1-bit field can indicate DFT-S-OFDM with multiple layers and a value of “1” can indicate CP-OFDM. The PHR corresponding to the currently used waveform that is the waveform used for a PUSCH transmission scheduled by a DCI format or with a configured grant, can be reported in a separate MAC CE that the one that provides information of the PHR corresponding to one or more waveforms different than the currently used waveform. The periodicities and/or timers for reporting the PHR of the currently used waveform and for reporting an information corresponding to one or more other waveforms can be configured independently. For example, the periodicity of reporting the information corresponding to one or more other waveforms than the currently used waveform can be larger than the periodicity of reporting the PHR corresponding to the used waveform. It is possible that while the PHR corresponding to the used waveform is reported periodically, the PHR reporting corresponding to a different waveform than the one used is triggered aperiodically by MAC CE.

In a first embodiment, a UE (e.g., UE 114) is configured to report a first PHR with a configured first periodicity, wherein the first PHR is associated with an actual waveform used for an actual transmission or for a reference transmission, and is configured to report an assumed (or second or nominal) PHR information associated with an assumed (or second or nominal) waveform, wherein the assumed (or second) PHR information can be an absolute PHR value or a relative (or difference) value between the first PHR and the assumed (or second) PHR. Alternatively or additionally, reporting of the first PHR can be triggered by MAC CE. If the assumed (or second) PHR information is reported, the UE(e.g., UE 114) can report first and assumed (or second) PHR information at the same time or at different times, and can use a same or different signaling. For example, the UE reports first and second PHR information in a same MAC CE, or the UE reports first PHR in a first MAC CE and second PHR in a second MAC CE, or the UE reports the first PHR in a first PUSCH triggered by a first DCI format, or the UE reports the second PHR in a second PUSCH triggered by a second DCI format.

In one example, a UE (e.g., UE 114) is configured by a first higher layer parameter to report an assumed (or alternative or second) PHR associated with an assumed (or alternative or second) waveform, is also configured by a second higher layer parameter whether a dynamic waveform switching field is present in a DCI format, wherein the second higher layer parameter can be set to “enabled” and the DCI format includes the dynamic waveform switching field, or the second higher layer parameter can be set to “disabled” and the DCI format does not include the dynamic waveform switching field. When the dynamic waveform switching field is included in the DCI format, a value “0” of dynamic waveform switching field indicates transform precoding enabled, and a value “1” of dynamic waveform switching field indicates transform precoding disabled. Whether the UE reports the assumed PHR or a difference value of the assumed PHR and the first PHR when the UE reports the first PHR can depend on whether the dynamic waveform switching field indicates a same or different waveform of the waveform configured by higher layer parameter TransformPrecoder, and/or on the DCI format, and/or on whether the first PHR or the assumed PHR is reported in a PUSCH scheduled or activated by the DCI format that includes the dynamic waveform switching bit.

For example, the second higher layer parameter is set to “enabled”, the DCI format includes a dynamic waveform switching field that indicates a waveform same as or different from the actual waveform configured by higher layer parameter TransformPrecoder, or from the actual waveform corresponding to the scheduled or activated PUSCH transmission by the DCI format, and the UE reports the assumed PHR or a difference value of the assumed PHR and the first PHR when the UE reports the first PHR.

In another example, the second higher layer parameter is set to “enabled”, and if the DCI format includes a dynamic waveform switching field that indicates a waveform different from the actual waveform configured by higher layer parameter TransformPrecoder, or from the actual waveform corresponding to the scheduled or activated PUSCH transmission by the DCI format, the UE reports the assumed PHR or a difference value of the assumed PHR and the first PHR when the UE reports the first PHR, otherwise the UE does not report the assumed PHR or a difference value of the assumed PHR and the first PHR when the UE reports the first PHR.

In more examples, the second higher layer parameter is set to “enabled”, the DCI format includes a dynamic waveform switching field that indicates a waveform same as or different from the actual waveform configured by higher layer parameter TransformPrecoder, or from the actual waveform corresponding to the scheduled or activated PUSCH transmission by the DCI format, and the UE reports the assumed PHR or a difference value of the assumed PHR and the first PHR when the UE reports the first PHR if the DCI format that includes the dynamic waveform switching field is (i) a DCI format 0_1 that schedules, or (ii) a DCI format 0_2 that activates, or (iii) a DCI format 0_3 that schedules in one or more cells, a PUSCH transmission, or PUSCH transmissions, including the assumed PHR or the difference value of the assumed PHR and the first PHR.

In additional examples, the second higher layer parameter is set to “enabled”, and if the DCI format includes a dynamic waveform switching field that indicates a waveform different from the actual waveform configured by higher layer parameter TransformPrecoder, or from the actual waveform corresponding to the scheduled or activated PUSCH transmission by the DCI format, the UE reports the assumed PHR or a difference value of the assumed PHR and the first PHR when the UE reports the first PHR if the DCI format that includes the dynamic waveform switching field is (i) a DCI format 0_1 that schedules, or (ii) a DCI format 0_2 that activates, or (iii) a DCI format 0_3 that schedules in one or more cells, a PUSCH transmission, or PUSCH transmissions, including the assumed PHR or the difference value of the assumed PHR and the first PHR, otherwise the UE does not report the assumed PHR or a difference value of the assumed PHR and the first PHR when the UE reports the first PHR.

In embodiments, a UE is configured a first higher layer parameter as enabled to report an assumed (or alternative or second) PHR associated with an assumed (or alternative or second) waveform, and is not configured a second higher layer parameter that indicates presence or absence of a dynamic waveform switching field in a DCI format.

For example, the UE reports the assumed PHR or a difference value of the assumed PHR and the first PHR when the UE reports the first PHR, wherein the assumed PHR is associated with a second waveform different from the first waveform corresponding to the first PHR.

In another example, the UE reports the assumed PHR or a difference value of the assumed PHR and the first PHR when the UE reports the first PHR, wherein the assumed PHR is associated with a second waveform and the second waveform is configured by higher layers.

In yet more examples, the UE reports the assumed PHR or a difference value of the assumed PHR and the first PHR when the UE reports the first PHR, wherein the assumed PHR is associated with a number of layers and the number of layers is configured by higher layers.

In an embodiment, a UE is configured to report an assumed (or second) PHR information associated with an assumed waveform. The assumed (or second) PHR information can be triggered by MAC CE, and/or can be reported with a configured second periodicity, and/or can be reported when the UE is also configured with a second higher layer parameter that indicates presence of a dynamic waveform switching field in a DCI format scheduling or activating a PUSCH transmission, wherein the dynamic waveform switching field in the DCI format can have a value of “0” to indicate transform precoding enabled or a value of “1” to indicate transform precoding disabled.

In one example, a UE reports an assumed PHR when the UE is configured with a second higher layer parameter that indicates presence of a dynamic waveform switching field in a DCI format scheduling or activating a PUSCH transmission, independently of the value of the dynamic waveform switching field.

In another example, a UE reports an assumed PHR when the UE is configured with a second higher layer parameter that indicates presence of a dynamic waveform switching field in a DCI format scheduling or activating a PUSCH transmission, when the dynamic waveform switching field indicates a waveform that is different from the actual waveform configured by higher layer parameter TransformPrecoder, or is different from the actual waveform corresponding to the scheduled or activated PUSCH transmission.

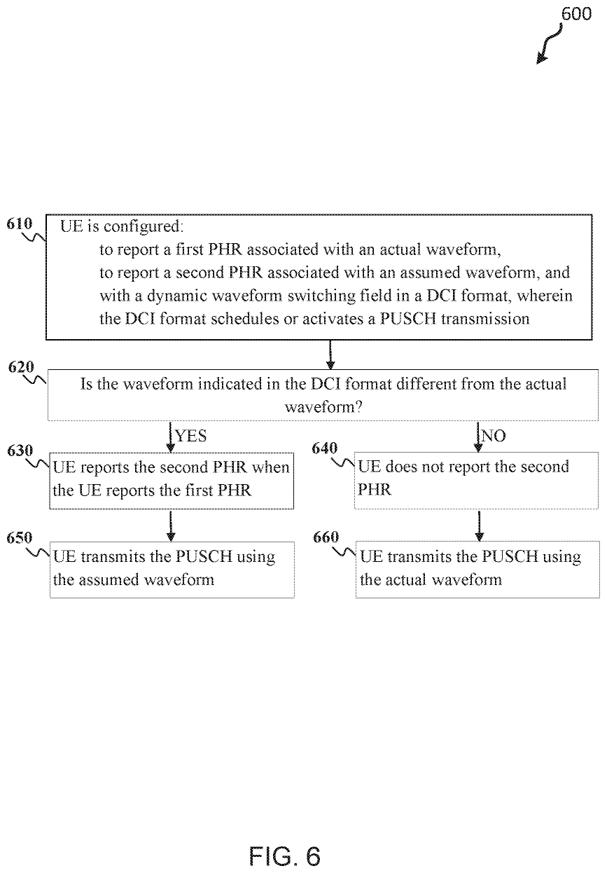

FIG. 6 illustrates a flowchart of a method 600 for a UE to provide a second PHR associated with an assumed waveform depending on the indication in a DCI format according to embodiments of the present disclosure. The embodiment of the flowchart of method 600 illustrated in FIG. 6 is for illustration only. FIG. 6 does not limit the scope of this disclosure to any particular implementation. In embodiments of this disclosure, the method 600 may be implemented in whole or in part as instructions, stored on a memory 360, executable by a processor 340 of a UE, e.g., UE 116. In embodiments of this disclosure, a corresponding version of the method 600 may be implemented in whole or in part as instructions, stored on a memory 230, executable by a processor 225 of a gNB, e.g., gNB 102.

At 610, A UE is configured: to report a first PHR associated with an actual waveform, to report a second PHR associated with an assumed waveform, and with a dynamic waveform switching field in a DCI format, wherein the DCI format schedules or activates a PUSCH transmission. At 620, when the waveform indicated in the DCI format is different from the actual waveform, the UE reports, at 630, the second PHR when the UE reports the first PHR. Otherwise, at 640, the UE does not report the second PHR. At 650, the UE transmits the PUSCH with the assumed waveform. At 660, the UE transmits the PUSCH with the actual waveform.

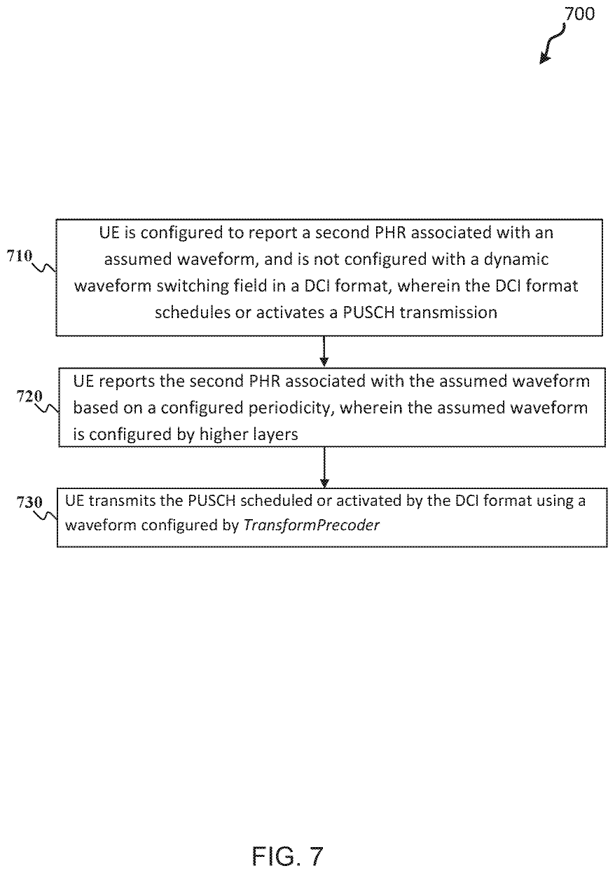

FIG. 7 illustrates a flowchart of a method 600 for a UE to provide a second PHR associated with an assumed waveform when the assumed waveform is not dynamically indicated according to embodiments of the present disclosure. The embodiment of the flowchart of method 700 illustrated in FIG. 7 is for illustration only. FIG. 7 does not limit the scope of this disclosure to any particular implementation. In embodiments of this disclosure, the method 700 may be implemented in whole or in part as instructions, stored on a memory 360, executable by a processor 340 of a UE, e.g., UE 116. In embodiments of this disclosure, a corresponding version of the method 700 may be implemented in whole or in part as instructions, stored on a memory 230, executable by a processor 225 of a gNB, e.g., gNB 102.

At 710, a UE is configured to report a second PHR associated with an assumed waveform, and is not configured with a dynamic waveform switching field in a DCI format, wherein the DCI format schedules or activates a PUSCH transmission. At 720, the UE reports the second PHR associated with the assumed waveform based on a configured periodicity, wherein the assumed waveform is configured by higher layers. At 730, the UE transmits the PUSCH scheduled or activated by the DCI format using a waveform configured by TransformPrecoder.

Descriptions above for reporting a first PHR information and a second PHR information that are associated with different waveforms equally apply for reporting of PHR information associated with different number of layers, or different MPR values, or different A-MPR values, or different P-MPR values. A first and a second number of layers can be configured by higher layer signaling. A first and second MPR (or A-MPR or P-MPR) values are determined by the UE based on implementation, and corresponding first and second PHR values would correspond to a first and second preferred operation mode by the UE.

A DCI format can include a 1-bit field to indicate a waveform switching wherein the DCI format can be a DCI format 0_0, 0_1, 0_2, or 0_3. For a DCI format scheduling a PUSCH transmission, or a DCI format activating a configured grant Type 2 PUSCH transmission, the PUSCH transmission occasion can be in the same slot where the waveform switching indication is received, or in a subsequent slot. The PUSCH transmission occasion can be in the same BWP where the waveform switching indication is received, or in a different BWP. The PUSCH transmission occasion can be in the same sub-band of a BWP where the waveform switching indication is received, or in a different sub-band. The PUSCH transmission occasion can be in the same cell or TRP where the waveform switching indication is received, or in a different cell or TRP.

A UE can be configured to report more than one PHRs that can correspond to PUSCH transmissions with different transmission settings, for example different waveform and/or different number of layers (different transmission rank). A first PHR of the more than one PHRs can correspond to transmission settings of the actual transmission and a second PHR of the more than one PHRs can correspond to transmission settings based on a configuration. The first and second PHRs can be reported independently in same or different PUSCH transmissions and in same or different MAC CEs. For example, the first PHR that corresponds to the transmission settings of the actual transmission can be reported when at least one parameter of the transmission settings changes, for example the waveform changes or the number of layers changes or the transmission rank changes, or when a set of parameters of the transmission settings change, for example the waveform and the number of layers change.

In one example, a PHR is reported in the first PUSCH transmission after the waveform changes, wherein the waveform change can be indicated in any of the DCI formats 0_0, 0_1, 0_2, or 0_3, and/or indicated by a higher layer configuration, and/or by a MAC CE. It is possible that the PHR is reported only when the waveform change is indicated in any of the DCI formats 0_0, 0_1, 0_2, or 0_3, or only in DCI format 0_1 or 0_2. It is also possible that the PHR is reported when the waveform change is indicated by a higher layer parameter, or when the waveform change is indicated by a MAC CE.

In another example, a PHR is reported in the first PUSCH transmission after the number of layers (or transmission rank) changes, wherein the change of number of layers (or transmission rank) can be indicated in any of the DCI formats 0_0, 0_1, 0_2, or 0_3, and/or indicated in a higher layer configuration, and/or by a MAC CE. It is possible that the PHR is reported only when the change of number of layers is indicated in any of the DCI formats 0_0, 0_1, 0_2, or 0_3, or only in DCI format 0_1 or 0_2. It is also possible that the PHR is reported when the change of number of layers is indicated by a higher layer parameter, or only when the change of number of layers is indicated by a MAC CE.

In yet another example, a PHR is reported in the first PUSCH transmission after the spatial settings change, wherein the change of spatial settings can be indicated in any of the DCI formats 0_0, 0_1, 0_2, or 0_3, and/or indicated in a higher layer configuration, and/or by a MAC CE. It is possible that the PHR is reported only when the change of spatial settings is indicated in any the DCI formats 0_0, 0_1, 0_2, or 0_3, or only in DCI format 0_1 or 0_2. It is also possible that the PHR is reported when the change of spatial settings is indicated by a higher layer parameter, or only when the change of spatial settings is indicated by a MAC CE.

In the above descriptions, i) the indication of the waveform change can be the indication to switch from one waveform to another waveform, or can be the indication of a different waveform from the waveform used by the UE or configured before the indication is received, ii) the indication of the change in number of layers (or transmission rank change) can be the indication to switch from one number of layers to another number of layers, or can be the indication of a different number of layers from the number of layers used by the UE or configured before the indication is received, and iii) the indication of the change of spatial setting or beam can be the indication to switch from one spatial setting to another spatial setting (or from a set of spatial settings to another set of spatial settings), or can be the indication of a different spatial setting (or a different set of spatial settings), used by the UE or configured before the indication is received.

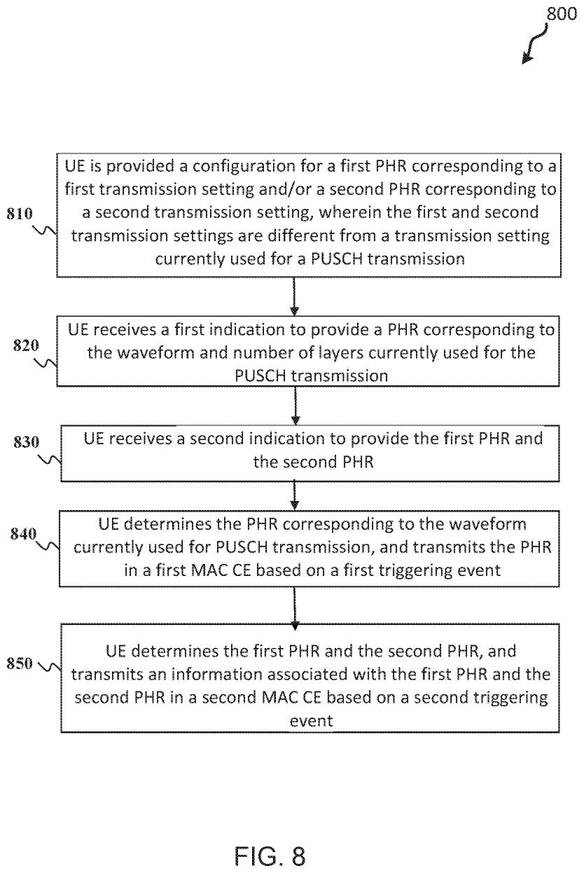

FIG. 8 illustrates a flowchart of a method 800 for a UE to provide one or more power headroom reports corresponding to the used transmission settings and/or to transmission settings different from the used transmission settings, wherein the transmission settings include a waveform and/or a number of layers (or transmission rank) that are indicated in a DCI format, according to embodiments of the present disclosure. The embodiment of the flowchart of method 800 illustrated in FIG. 8 is for illustration only. FIG. 8 does not limit the scope of this disclosure to any particular implementation. In embodiments of this disclosure, the method 800 may be implemented in whole or in part as instructions, stored on a memory 360, executable by a processor 340 of a UE, e.g., UE 116. In embodiments of this disclosure, a corresponding version of the method 800 may be implemented in whole or in part as instructions, stored on a memory 230, executable by a processor 225 of a gNB, e.g., gNB 102.

At 810, a UE is provided a configuration for a first PHR corresponding to a first transmission setting with a first waveform and a first number of layers and/or a second PHR corresponding to a second transmission setting with a second waveform and/or a second number of layers, wherein the first and second transmission settings are different from a transmission setting currently used for a PUSCH transmission. For example, the waveform currently used is DFT-S-OFDM with single layer, the first waveform is DFT-S-OFDM with multiple layers and the second waveform is CP-OFDM with same (or different) number of layers used by the first waveform. At 820, the UE receives a first indication to provide a PHR corresponding to the waveform and number of layers currently used for the PUSCH transmission. At 830, the UE receives a second indication to provide the first PHR and the second PHR. At 840, the UE determines the PHR corresponding to the waveform currently used for PUSCH transmission, and transmits the PHR in a first MAC CE based on a first triggering event. At 850, the UE determines the first PHR and the second PHR, and transmits an information associated with the first PHR and the second PHR in a second MAC CE based on a second triggering event.

As illustrated in FIG. 8, in steps 820 and 830, the UE can receive an indication to provide a power headroom report corresponding to a PUSCH transmissions with transmission settings indicated by a DCI format or by higher layers.

A DCI format scheduling a PUSCH transmission, or a DCI format activating a configured grant Type 2 PUSCH transmission, can include a 1-bit field to indicate whether or not to report the PHR in the PUSCH transmission, wherein the bit value of “0” can indicate no PHR reporting and the bit value of “1” can indicate PHR reporting, or vice versa. For the PHR reporting field in the DCI format, the presence of the field and/or the indication provided by the field may or may not depend on the presence and/or the indication of waveform switching.

In one example, the DCI format including the dynamic waveform switching indication field also includes the PHR reporting indication field. The configuration of presence of 1-bit dynamic waveform switching indication in DCI format 0_0 or 0_1 or 0_2 or 0_3, wherein the configuration can be a separate configuration for each DCI format or a common configuration for the DCI formats, implicitly indicates the presence of the PHR reporting field. Thus, for a PUSCH scheduled by DCI format 0_0 or 0_1 or 0_2 or 0_3 with dynamic waveform switching indication field configured, the UE expects that the DCI format includes the PHR reporting field. In this case, the configuration of presence of the dynamic waveform switching indication field implies the presence of the PHR reporting indication field, and a separate configuration of presence of the PHR reporting indication field is not needed.

In one example, the DCI format including the dynamic waveform switching indication field includes the PHR reporting indication field if the dynamic waveform switching indication field indicates to change or switch waveform. If the 1-bit dynamic waveform switching indicates a waveform different than the configured waveform that is based on whether the higher layer parameter transform precoding is enabled or disabled, the DCI format also includes the PHR reporting indication field. If the 1-bit dynamic waveform switching indicates the same waveform as the configured waveform that is based on whether the higher layer parameter transform precoding is enabled or disabled, the DCI format does not include the PHR reporting indication field. Thus, for a PUSCH scheduled by DCI format 0_0 or 0_1 or 0_2 or 0_3 with dynamic waveform switching indication field configured that indicates a waveform change (that is the indicated waveform in DCI format is different from the configured waveform by higher layers, or the indicated waveform in DCI format is different from the waveform used in a preceding PUSCH transmission), the UE expects that the DCI format includes the PHR reporting field. The position of the PHR reporting field in the DCI format is after the dynamic waveform switching field. It is possible that the dynamic waveform switching indication field and the PHR reporting indication field are both configured, and when the dynamic waveform switching indication is to change waveform, the UE determines whether or not to transmit the PHR reporting based on the indication in the PHR reporting field of the DCI format, and when the dynamic waveform switching indication is not to change waveform, the UE does not to transmit the PHR reporting and ignores the indication in the PHR reporting field of the DCI format.

In one example, the dynamic waveform switching indication field and the PHR reporting indication field are both configured, and the UE separately determines whether to change waveform based on the dynamic waveform switching indication field of the DCI format and whether to report the PHR based on the indication in the PHR reporting field of the DCI format. Thus, when the DCI format scheduling a PUSCH transmission, or the DCI format activating a configured grant Type 2 PUSCH transmission, that includes a 1-bit field to indicate the waveform of the PUSCH transmission and a 1-bit field to indicate whether or not to report the PHR corresponding to the PUSCH transmission, the UE may switch waveform and/or report the PHR, or not switch waveform and not report the PHR.

A DCI format scheduling a PUSCH transmission, or a DCI format activating a configured grant Type 2 PUSCH transmission, can include a 2-bit field to indicate a waveform switching and whether or not to report the PHR in the PUSCH transmission, wherein the first bit indicates the waveform switching and the second bit indicates PHR reporting. Thus, the value of “00” can indicate no waveform switching and no PHR reporting, the value of “01” can indicate no waveform switching and PHR reporting, the value of “10” can indicate waveform switching and no PHR reporting, and the value of “11” can indicate waveform switching and PHR reporting.

A DCI format can include a 1-bit field to indicate whether or not to report a PHR in the first PUSCH transmission occasion after reception of the indication and not include a 1-bit field to indicate a waveform switching, wherein the DCI format can be a DCI format 0_0, 0_1, 0_2, or 0_3. The PUSCH transmission occasion can be in the same slot where the PHR reporting indication is received, or in a subsequent slot. The PUSCH transmission occasion can be in the same BWP where the PHR reporting indication is received, or in a different BWP. The PUSCH transmission occasion can be in the same sub-band of a BWP where the PHR reporting indication is received, or in a different sub-band. The PUSCH transmission occasion can be in the same cell or TRP where the PHR reporting indication is received, or in a different cell or TRP.

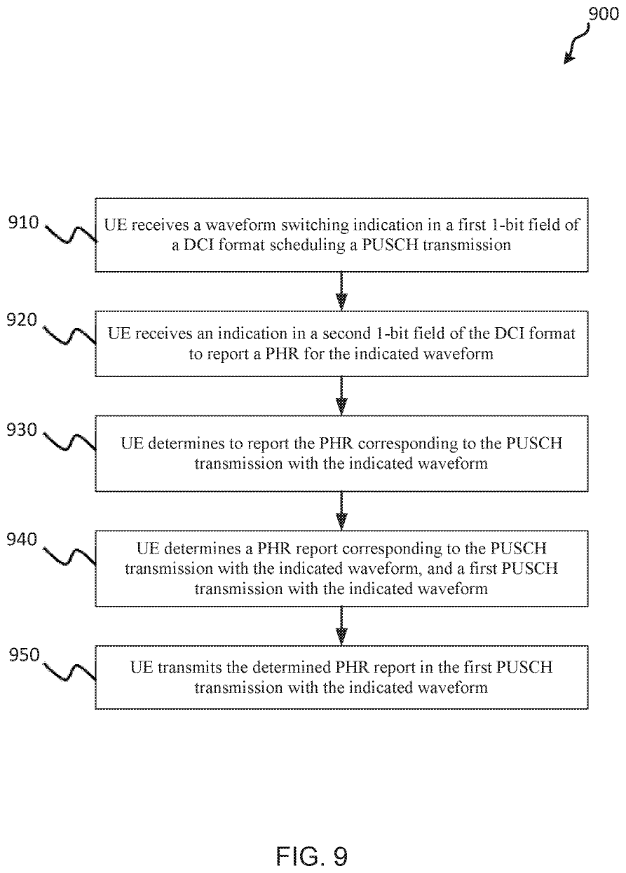

FIG. 9 illustrates a flowchart of a method 900 for PHR reporting based on an indication in a DCI format, after a waveform switching indication, according to embodiments of the present disclosure. The embodiment of the flowchart of method 900 illustrated in FIG. 9 is for illustration only. FIG. 9 does not limit the scope of this disclosure to any particular implementation. In embodiments of this disclosure, the method 900 may be implemented in whole or in part as instructions, stored on a memory 360, executable by a processor 340 of a UE, e.g., UE 116. In embodiments of this disclosure, a corresponding version of the method 900 may be implemented in whole or in part as instructions, stored on a memory 230, executable by a processor 225 of a gNB, e.g., gNB 102.

At 910, a UE receives a waveform switching indication in a first 1-bit field of a DCI format scheduling a PUSCH transmission. At 920, the UE receives an indication in a second 1-bit field of the DCI format to report a PHR for the indicated waveform. At 930, the UE determines to report the PHR corresponding to the PUSCH transmission with the indicated waveform. At 940, the UE determines a PHR report corresponding to the PUSCH transmission with the indicated waveform, and a first PUSCH transmission with the indicated waveform. At 950, the UE transmits the determined PHR report in the first PUSCH transmission with the indicated waveform.

When a DCI format scheduling a PUSCH transmission or a DCI format activating a configured grant Type 2 PUSCH transmission, includes a field to indicate the waveform of the PUSCH transmission and does not include a field to indicate to report the PHR corresponding to the PUSCH transmission, the UE may transmit the PHR report corresponding to the PUSCH transmission with the indicated waveform. Whether or not to transmit the PHR report can be subject to a configuration.

For example, PHR reporting can be enabled or disabled by a higher layer parameter (e.g., PHR-enabled, or PHR-Reporting, or Dynamic-PHR-Reporting, or PHR-assumed-transmission), and if enabled, a UE transmits the PHR report when there is a waveform change indicated in a DCI format. Thus, the waveform switching indication in the DCI format is an event that triggers PHR reporting.

For example, if PHR reporting is enabled, a UE transmits the PHR report when a dynamic waveform switching field is present in a DCI format. Thus, the presence of the dynamic waveform switching field in the DCI format is an event that triggers PHR reporting.

It is possible that if the waveform switching is indicated by a higher layer parameter or by MAC CE and PHR reporting is enabled, a UE transmits the PHR report corresponding to the PUSCH transmission with the indicated waveform. In this case, the waveform switching indication by a higher layer parameter or by MAC CE is an event that triggers PHR reporting.

When PHR reporting is enabled, and a new number of layers (or new transmission rank) for the PUSCH transmission is indicated in a DCI format or in a higher layer parameter or by MAC CE, the UE transmits the PHR corresponding to the PUSCH transmission with the indicated new number of layers. Thus, the indication of the new number of layers is an event that triggers PHR reporting. It is possible that only when the new number of layers (or new transmission rank) for the PUSCH transmission is indicated in the DCI format is an event that triggers PHR reporting.

When PHR reporting is enabled, and a new spatial setting (or a new set of spatial settings) for the PUSCH transmission is indicated in a DCI format or in a higher layer parameter or by MAC CE, the UE transmits the PHR report corresponding to the PUSCH transmission with the indicated spatial setting (or the new set of spatial settings). Thus, the indication of the new spatial setting(s) can be considered an event that causes PHR reporting. It is possible that only when the new spatial setting (or new set of spatial settings) for the PUSCH transmission indicated in the DCI format is an event that triggers PHR reporting.

PHR reporting can be enabled separately for each event such as waveform switching, rank change, or spatial settings change, or can be enabled for more than one events. An event that triggers the PHR report can be an indication of change of waveform/rank/spatial setting when provided in a DCI format, while the indication provided by higher layer signalling may not trigger PHR reporting. For example, a waveform indication in a DCI format scheduling a PUSCH transmission or a DCI format activating a configured grant Type 2 PUSCH transmission is an event that triggers PHR reporting, and a waveform indication in a higher layer parameter or in a MAC CE is not an event that triggers PHR reporting.

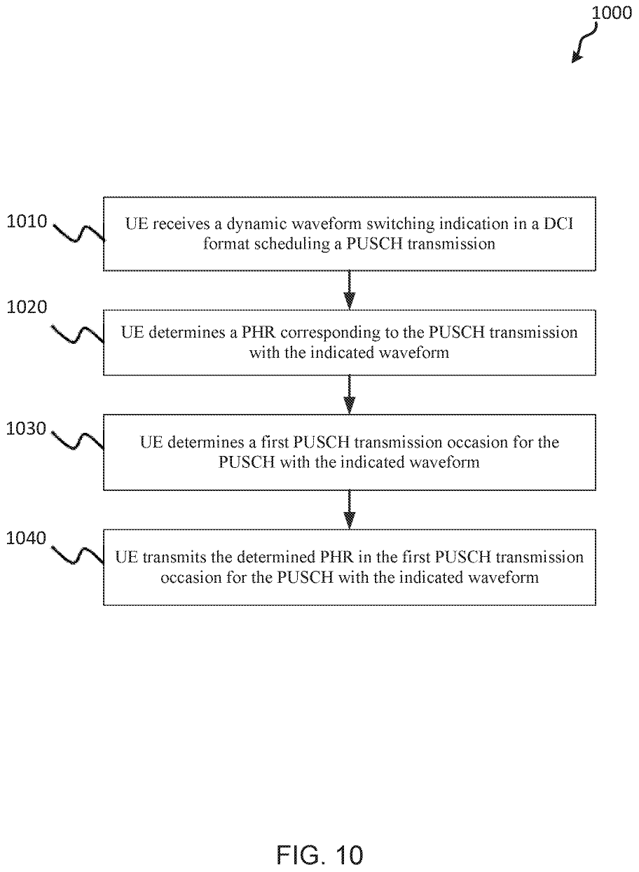

FIG. 10 illustrates a flowchart of a method 1000 for PHR reporting corresponding to a waveform indicated in a DCI format when a UE receives a dynamic waveform switching indication according to embodiments of the present disclosure. The embodiment of the flowchart of method 1000 illustrated in FIG. 10 is for illustration only. FIG. 10 does not limit the scope of this disclosure to any particular implementation. In embodiments of this disclosure, the method 1000 may be implemented in whole or in part as instructions, stored on a memory 360, executable by a processor 340 of a UE, e.g., UE 116. In embodiments of this disclosure, a corresponding version of method 1000 may be implemented in whole or in part as instructions, stored on a memory 230, executable by a processor 225 of a gNB, e.g., gNB 102.

At 1010, a UE receives a dynamic waveform switching indication in a DCI format scheduling a PUSCH transmission. At 1020, the UE determines a PHR corresponding to the PUSCH transmission with the indicated waveform. At 1030, the UE determines a first PUSCH transmission occasion for the PUSCH with the indicated waveform. At 1040, the UE transmits the determined PHR in the first PUSCH transmission occasion for the PUSCH with the indicated waveform. In various embodiments, additionally or alternatively, the waveform indicated by the dynamic waveform switching field of the DCI format can be same as or different from the waveform indicated by an earlier DCI format received in the same BWP, or in the same cell, or in the same TRP; or the waveform indicated by the dynamic waveform switching field of the DCI format can be same as or different from the waveform indicated by a higher layer parameter, for example by transformPrecoder.

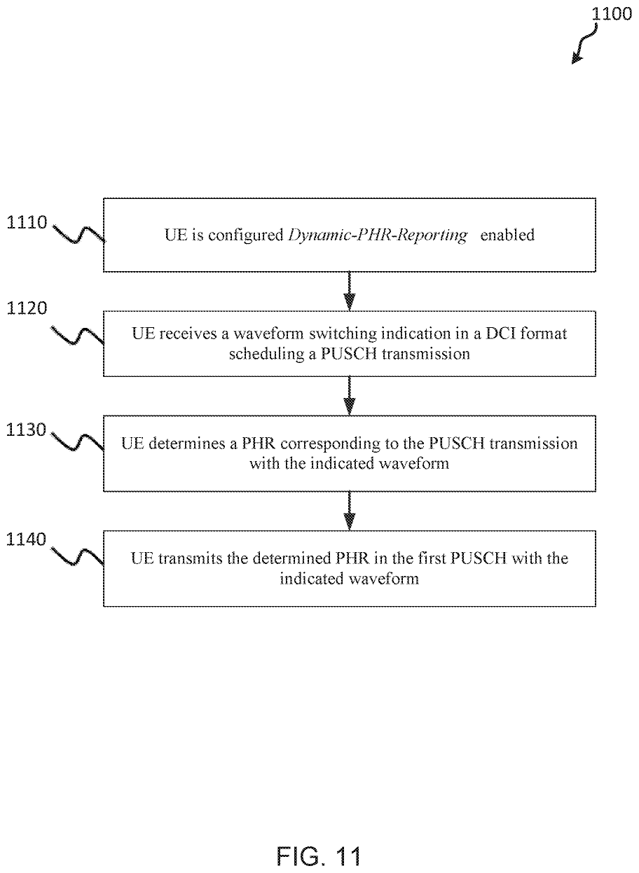

FIG. 11 illustrates a flowchart of a method 1100 for PHR reporting subject to a configuration that enables PHR reporting according to embodiments of the present disclosure. The embodiment of the flowchart of method 1100 illustrated in FIG. 11 is for illustration only. FIG. 11 does not limit the scope of this disclosure to any particular implementation. In embodiments of this disclosure, the method 1100 may be implemented in whole or in part as instructions, stored on a memory 360, executable by a processor 340 of a UE, e.g., UE 116. In embodiments of this disclosure, a corresponding version of method 1100 may be implemented in whole or in part as instructions, stored on a memory 230, executable by a processor 225 of a gNB, e.g., gNB 102.

At 1110, a UE is configured Dynamic-PHR-Reporting enabled. At 1120, the UE receives a waveform switching indication in a DCI format scheduling a PUSCH transmission. At 1130, the UE determines a PHR corresponding to the PUSCH transmission with the indicated waveform. At 1140, the UE transmits the determined PHR in the first PUSCH with the indicated waveform.

When a PUSCH transmission is scheduled with repetitions over a number of slots, a PHR is reported in a first PUSCH repetition in a first slot. If the first slot is not available for the PUSCH transmission, the PHR is reported in a subsequent slot where the first PUSCH transmission occurs.

When a UE supports dynamic waveform switching, the UE can receive a waveform switching indication in a DCI format scheduling a PUSCH transmission or a DCI format activating a configured grant Type 2 PUSCH transmission, and based on the indication, transmit the PUSCH with the indicated waveform. It is possible that the UE that supports dynamic waveform switching, supports also to transmit a power headroom corresponding to the PUSCH transmission with the indicated waveform in the first PUSCH transmission after the waveform switching indication. Thus, a UE capability can include support of dynamic waveform switching and of PHR reporting in the first PUSCH transmission after the waveform switching. It is also possible that support of dynamic waveform switching and support of PHR reporting in the first PUSCH transmission after the waveform switching are two separate capabilities. It is also possible that the PHR reporting capability is associated to a change in the number of layers of the PUSCH transmission, or to a change of spatial setting of the PUSCH transmission.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE) comprising:
a transceiver configured to receive:
information indicating that a first downlink control information (DCI) format scheduling a transmission of a physical uplink shared channel (PUSCH) includes a transform precoding indication (TPI) field, wherein the TPI field indicates a first transform precoding or a second transform precoding for the transmission of the PUSCH, and
a physical downlink control channel (PDCCH) providing a DCI format scheduling a transmission of a first PUSCH; and
a processor operably coupled to the transceiver, the processor configured to determine:
whether the DCI format is the first DCI format or a second DCI format, wherein the second DCI format does not include the TPI field, and
a power headroom report (PHR), wherein:
when the DCI format is the second DCI format, the PHR includes a single PHR associated with a transform precoding used for the transmission of the first PUSCH, and
when the DCI format is the first DCI format, the PHR includes a first PHR associated with the first transform precoding for the transmission of the first PUSCH and a second PHR associated with the second transform precoding for the transmission of the first PUSCH,
wherein the transmission of the first PUSCH uses either the first transform precoding or the second transform precoding, and
wherein the transceiver is further configured to transmit the first PUSCH with the PHR.

2. The UE of claim 1, wherein:
the DCI format is the first DCI format,
the transmission of the first PUSCH uses the first transform precoding, and
the second PHR is a maximum output power for the transmission of the first PUSCH associated with the second transform precoding.

3. The UE of claim 1, wherein:
the DCI format is the first DCI format,
the transmission of the first PUSCH uses the first transform precoding, and
the second PHR is a maximum output power for the transmission of the first PUSCH associated with the first transform precoding.

4. The UE of claim 1, wherein the TPI field indicates whether transform precoding is enabled or disabled.

5. The UE of claim 1, wherein:
the PHR includes the first PHR and the second PHR, and
the first PHR and the second PHR are provided by a single medium access control (MAC) control element (CE).

6. The UE of claim 5, wherein the single MAC CE is one of:
a single-entry PHR MAC CE identified by a first MAC subheader with first logical cell ID (LCID), or
a multiple-entry PHR MAC CE identified by a second MAC subheader with second LCID.

7. The UE of claim 1, wherein:
the PHR includes the first PHR and the second PHR only when a transform precoding used for the transmission of the first PUSCH is different than a transform precoding used for a transmission of a second PUSCH that is immediately preceding the transmission of the first PUSCH, and
the transform precoding used for the transmission of the first PUSCH is different than the transform precoding used for the transmission of the second PUSCH.

8. A base station (BS) comprising:
a transceiver configured to transmit:
information indicating that a first downlink control information (DCI) format scheduling a reception of a physical uplink shared channel (PUSCH) includes a transform precoding indication (TPI) field, wherein the TPI field indicates a first transform precoding or a second transform precoding for the reception of the PUSCH, and
a physical downlink control channel (PDCCH) providing a DCI format scheduling a reception of a first PUSCH; and
a processor operably coupled to the transceiver, the processor configured to determine:
whether the DCI format is the first DCI format or a second DCI format, wherein the second DCI format does not include the TPI field, and
a power headroom report (PHR), wherein:
when the DCI format is the second DCI format, the PHR includes a single PHR associated with a transform precoding used for the reception of the first PUSCH, and
when the DCI format is the first DCI format, the PHR includes a first PHR associated with the first transform precoding for the reception of the first PUSCH and a second PHR associated with the second transform precoding for the reception of the first PUSCH,
wherein the reception of the first PUSCH is associated with either the first transform precoding or the second transform precoding, and
wherein the transceiver is further configured to receive the first PUSCH with the PHR.

9. The BS of claim 8, wherein:
the DCI format is the first DCI format,
the reception of the first PUSCH is associated with the first transform precoding, and
the second PHR is a maximum output power for the reception of the first PUSCH associated with the second transform precoding.

10. The BS of claim 8, wherein:
the DCI format is the first DCI format,
the reception of the first PUSCH is associated with the first transform precoding, and
the second PHR is a maximum output power for the reception of the first PUSCH associated with the first transform precoding.

11. The BS of claim 8, wherein the TPI field indicates whether transform precoding is enabled or disabled.

12. The BS of claim 8, wherein:
the PHR includes the first PHR and the second PHR,
the first PHR and the second PHR are provided by a single medium access control (MAC) control element (CE), and
the single MAC CE is one of:
a single-entry MAC CE PHR identified by a first MAC subheader with first logical cell ID (LCID), or
a multiple-entry MAC CE PHR identified by a second MAC subheader with second LCID.

13. The BS of claim 8, wherein:
the PHR includes the first PHR and the second PHR only when a transform precoding used for the reception of the first PUSCH is different than a transform precoding used for a reception of a second PUSCH that is immediately preceding the reception of the first PUSCH, and
the transform precoding used for the reception of the first PUSCH is different than the transform precoding used for the reception of the second PUSCH.

14. A method comprising:
receiving:
information indicating that a first downlink control information (DCI) format scheduling a transmission of a physical uplink shared channel (PUSCH) includes a transform precoding indication (TPI) field, wherein the TPI field indicates a first transform precoding or a second transform precoding for the transmission of the PUSCH, and
a physical downlink control channel (PDCCH) providing a DCI format scheduling a transmission of a first PUSCH;
determining:
whether the DCI format is the first DCI format or a second DCI format, wherein the second DCI format does not include the TPI field, and
a power headroom report (PHR), wherein:
when the DCI format is the second DCI format, the PHR includes a single PHR associated with a transform precoding used for the transmission of the first PUSCH, and
when the DCI format is the first DCI format, the PHR includes a first PHR associated with the first transform precoding for the transmission of the first PUSCH and a second PHR associated with the second transform precoding for the transmission of the first PUSCH; and
transmitting the first PUSCH with the PHR, wherein the transmission of the first PUSCH uses either the first transform precoding or the second transform precoding.

15. The method of claim 14, wherein:
the DCI format is the first DCI format,
the transmission of the first PUSCH uses the first transform precoding, and
the second PHR is a maximum output power for the transmission of the first PUSCH associated with the second transform precoding.

16. The method of claim 14, wherein:
the DCI format is the first DCI format,
the transmission of the first PUSCH uses the first transform precoding, and
the second PHR is a maximum output power for the transmission of the first PUSCH associated with the first transform precoding.

17. The method of claim 14, wherein the TPI field indicates whether transform precoding is enabled or disabled.

18. The method of claim 14, wherein:
the PHR includes the first PHR and the second PHR, and
the first PHR and the second PHR are provided by a single medium access control (MAC) control element (CE).

19. The method of claim 18, wherein the single MAC CE is one of:
a single-entry PHR MAC CE identified by a first MAC subheader with first logical cell ID (LCID), or
a multiple-entry PHR MAC CE identified by a second MAC subheader with second LCID.

20. The method of claim 14, wherein:
the PHR includes the first PHR and the second PHR only when a transform precoding used for the transmission of the first PUSCH is different than a transform precoding used for a transmission of a second PUSCH that is immediately preceding the transmission of the first PUSCH, and
the transform precoding used for the transmission of the first PUSCH is different than the transform precoding used for the transmission of the second PUSCH.
